(19) United States
(12) Patent Application Publication
(10) Pub. No.: US 2024/0258518 A1
(43) Pub. Date: Aug. 1, 2024

(54) ARCHITECTED TRANSITION METAL DICHALCOGENIDE FOAM AND METHOD

(71) Applicants: KING ABDULLAH UNIVERSITY OF SCIENCE AND TECHNOLOGY, Thuwal (SA); SAUDI ARABIAN OIL COMPANY, Dhahran (SA)

(72) Inventors: Vincent Chun-Chih TUNG, Emeryville, CA (US); Xuan WEI, Jinzhong (CN); Jui-Han FU, Hualien (TW); Wei XU, Thuwal (SA); Lianhui DING, Dhahran (SA)

(21) Appl. No.: 18/565,599

(22) PCT Filed: Jun. 17, 2022
(86) PCT No.: PCT/IB2022/055653

§ 371 Date: Nov. 30, 2023

Related U.S. Application Data
(60) Provisional application No. 63/212,775, filed on Jun. 21, 2021.

(51) Int. Cl. H01M 4/58; H01M 4/02; H01M 4/04; H01M 4/36

(52) U.S. Cl. CPC H01M 4/5815; H01M 4/0419; H01M 4/366; H01M 2004/021; H01M 2004/027

(57) ABSTRACT

An architected transitional metal dichalcogenides, TMD, foam includes plural layers of TMD arranged on top of each other along a given first direction Z, each layer including plural cells, each cell being defined by one or more struts made of the TMD; plural channels extending along a given second direction M, which makes an angle α with the first given direction Z; and plural pores formed on sides of the plural channels.

### CROSS-REFERENCE TO RELATED APPLICATIONS

This application claims priority to U.S. Provisional Patent Application No. 63/212,775, filed on Jun. 21, 2021, entitled “ARCHITECTED TRANSITION METAL DICHALCOGENIDES FOAM,” the disclosure of which is incorporated herein by reference in its entirety.

### BACKGROUND

### Technical Field

Embodiments of the subject matter disclosed herein generally relate to an architected foam, anode, and method for making the foam, and more particularly, to an architected transition metal dichalcogenide material that can be used as a high performance anode that is conducive to a high battery yield, and high dynamic recovery to withstand excessive volume expansion.

### Discussion of the Background

With the rapid advancement of smart devices, electrical vehicles and a myriad of sensors and cameras that monitor our environment, not only the communication part of this new environment is experiencing a large pressure for providing more data, but the energy sources that power these mobile or remote devices are also facing an unprecedent pressure for delivering more energy for the same or even smaller footprint.

The Lithium (Li) batteries have established themselves as the leader in this portable energy supply revolution. While the cathode materials used for these batteries may utilize a large number of structures, the anode material has proved to be more difficult to be engineered. Graphite was the initial material of choice for the anodes in the Li-based batteries. However, the graphite has a very low specific capacity and thus, it is not very efficient. Recently, metal oxides including TiO₂, MnO₂ and NiO have been tested as they have a better capacity than the graphite. More recently, graphene nanosheets, 2D transition-metal dichalcogenide (TMD) materials, MXene and other materials have been proposed for the anode of the Li-based batteries.

In this regard, materials with three-dimensional (3D), hierarchical architectures exhibit new and greatly enhanced mechanical, energy conversion as well as optical and thermal radiative cooling properties not found in their bulk counterparts [1]-[3]. For example, a good candidate for these novel architectures is the TMD. TMD monolayers are atomically thin semiconductors of the type MX₂, with M being a transition-metal atom (e.g., Mo, W, etc.) and X being a chalcogen atom (e.g., S, Se, or Te). For the architected TMD material, one layer of M atoms is sandwiched between two layers of X atoms. These materials are part of the large family of so-called 2D materials, named so to emphasize their extraordinary thinness. For example, a MoS₂ monolayer is only 6.5 Å thick.

However, implementation of hierarchically structured 3D TMDs is widely deemed not possible, in part, by the lack of manufacturing solutions that overcome the hierarchy, quality, and scalability dilemma. It is noted that manufacturing processes for obtaining the 2D layered TMD materials are known. However, the manufacturing processes for the 3D structures of TMD materials are more challenging as it is not enough only to place 2D layers on top of each other to obtain a 3D structure. The aim for the 3D engineered/architected materials is to confer various properties to these 3D architected materials that are not present in the simple 2D piled up materials. Such properties would be, for example, channels, viaducts, structural cells, nanopores, etc. having various dimensions, from angstroms to centimeters. These novel properties that are missing in the 2D structures or the piled up 2D structures make the architected 3D material to be special, i.e., to have electrochemical and mechanical capabilities that surpass the performance of the existing materials used for the battery's anodes while, at the same time, the technique for making such materials is easily transferred into a large scale and economical manufacturing facility.

Thus, there is a need for a new 3D architected material and a scalable method of making the material so that it has very good electrical and mechanical capabilities for the anode of a battery.

### BRIEF SUMMARY OF THE INVENTION

According to an embodiment, there is an architected transitional metal dichalcogenide, TMD, foam that includes plural layers of TMD arranged on top of each other along a given first direction Z, each layer including plural cells, each cell being defined by one or more struts made of the TMD. The TMD foam further includes plural channels extending along a given second direction M, which makes an angle α with the first given direction Z, and plural pores formed on sides of the plural channels.

According to another embodiment, there is a battery for producing electrical energy and the battery includes an anode including an architected transitional metal dichalcogenide, TMD, foam, a cathode, a separating membrane that separates the anode from the cathode, and an electrolyte. The architected TMD foam includes plural channels having nanometer sized internal diameters.

According to yet another embodiment, there is a method for manufacturing an architected transitional metal dichalcogenide, TMD, foam. The method includes providing bulk TMD, chemically exfoliating TMD nanosheets from the bulk TMD to obtain chemically exfoliated ce-TMD, spraying with a nozzle the ce-TMD as a jet onto a substrate to form a layer of TMD material with a thickness below a critical thickness, applying a voltage between the nozzle and the substrate, spraying with the nozzle the ce-TMD as particles onto the layer of TMD material, and forming plural channels through the layer by dewetting the layer.

### BRIEF DESCRIPTION OF THE DRAWINGS

For a more complete understanding of the present invention, reference is now made to the following descriptions taken in conjunction with the accompanying drawings, in which:

FIG. 1 is a flow chart of a method for manufacturing an architected TMD foam having enhanced electrical properties;

FIG. 2 illustrates a system used for manufacturing the architected TMD foam;

FIG. 3 illustrates a printing process and associated system for forming the architected TMD foam;

FIG. 4 illustrates nanopores and struts formed in the architected TMD foam;

FIG. 5 schematically illustrates the various features of the 3D configuration of the architected TMD foam;

FIG. 6 illustrates plural truss unit cells that extend in various parallel planes of TMD material and form a channel;

FIG. 7 illustrates a load and displacement curve for the architected TMD foam, which displays a ductile-like feature with continuous serrated flow indicated by arrows;

FIG. 8 illustrates various 3D configurations of the TMD material and associated internal configurations;

FIG. 9 is a schematic illustration of a channel being defined by plural cells, each cell being defined by plural struts, and the cells being connected to each other by vertical viaducts;

FIGS. 10A and 10B illustrate galvano-static discharge and charge profiles measured at constant and different current densities for the architected TMD foam;

FIG. 11 illustrates the cycling performance of an architected TMD foam anode measured at current densities of 5 A/g and 10 A/g, respectively;

FIG. 12 illustrates the diffusion coefficient values (DLit) in terms of logarithms to the base 10 of architected MoS₂ foam juxtaposed with MoS₂ bulks when measured under various potentials versus Li/Li⁺;

FIG. 13 shows Nyquist plots of foam, crumples, wrinkles and bulks based on MoS₂ material having different 3D configurations;

FIG. 14A shows a high areal mass loading test (up to 3.5 mg cm⁻² active material) of architected MoS₂ foam anodes;

FIG. 14B shows the volumetric capacity of the architected MoS₂ foam outperforming the various state-of-the-art anodes and comparing favorably to the current benchmark of BP composite anodes; and

FIG. 15 is a schematic of a battery that uses architected TMD foam as the anode.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a foam that can be used as the anode of a Li-based battery. However, the embodiments to be discussed next are not limited to the anode of a Li-based battery, but may be applied to other structures, for example, capacitors, catalysts, membranes, reflective coatings, anti-corrosion layers, biofouling-resistant surfaces, heat-absorber matrices, composites, passive daytime radiative cooling materials, templates, shielding, hydrogel, sensors, etc. The foam discussed herein can be painted, sprayed, coated, printed, or additively manufactured on the target surfaces through evaporation induced pattern-formation.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a 4-inch-wafer-scale printing of architected Molybdenum disulfide (MoS₂) foam is manufactured and used as the active anode for high rate, high capacity, and high loading lithium (Li)-storage. Note that the 4-inch wafer is used as an example and any size wafer may be used. Specifically, the structural hierarchy of the novel architected MoS₂ foam increases proportionally where a concentric vortex-like intricacy feature merges technological merits from the architecture, mechanical engineering and electrochemistry, which are not found in its bulk or exfoliated/epitaxy counterparts. As a result, the electrochemical performance equals or surpasses those state-of-the-art anode designs while the technique offers an evaporation-like simplicity for industrial scalability.

As discussed next, a method that enables template-free, high throughput, and 4-inch-wafer-scale printing of 3D architected MoS₂ foam with disparate 3D structural features spanning seven orders of magnitude—from angstroms to centimeters, is introduced. For each order of magnitude, different properties are achieved. This method combines electrohydrodynamic printing with dewetting-induced-patterning. This technique can be applied to a range of other two-dimensional (2D) layered materials, including MXene (Ti₃C₂Tₓ) and reduced graphene oxide (rGO). Thus, although the method is discussed herein with regard to the MoS₂ material, it can equally be applied to MXene or rGO materials.

The deposited MoS₂ foam achieves, at the macroscale, amplification of resilience, recovers from deformation, displays the capability to convert from semi-insulator to conductor, and the construction of hierarchically porous and spatially interconnected networks for both ions and electrons, which are not found in their brittle-like monolayer constituents. Experiments were performed on the obtained architected material that demonstrate the first wafer-scale batch fabrication of 3D MoS₂ architected foam that can be fabricated into high-performance anodes with an otherwise unachievable combination of a 99% battery yield, a dynamic recovery (up to 85%) to withstand excessive volume expansion, a strain-induced reduction in diffusion barrier (0.2 eV), rapid diffusion of electrolyte ions and improved electron transport abilities across the entire structure. The result of this method is the high Li-ion charge storage capacity with robust cycling stability at a bulk scale (˜3.5 mg/cm²), and under a high current density (10,000 mA/g). It is noted that the achieved performance is on par with, or surpasses those of state-of-the-art anodes made of black phosphorus composites, Si-graphene and mesoporous graphene particles anodes, while the technique offers an evaporation-like simplicity for industrial scalability.

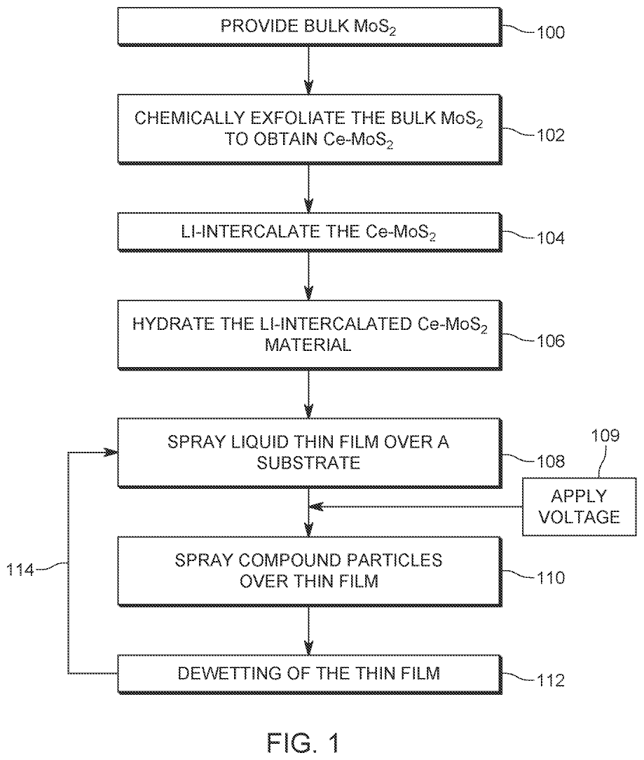

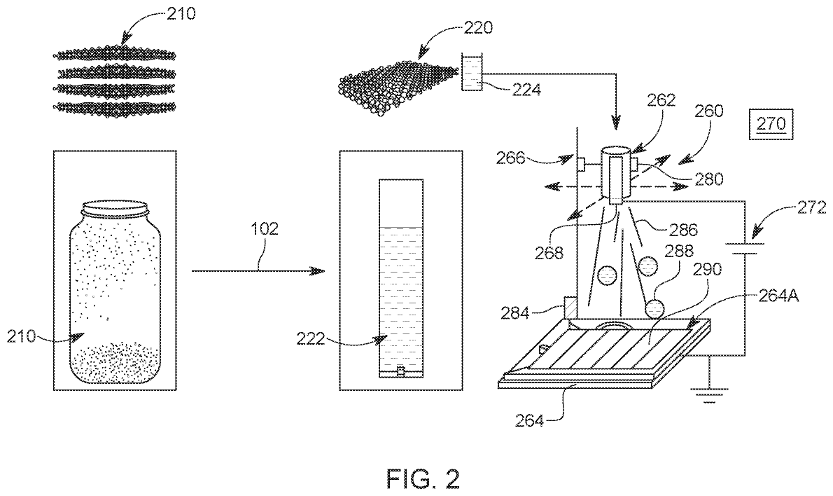

The manufacturing method of the MoS₂ architected foam is illustrated in FIG. 1 and starts with a step 100 of providing a bulk MoS₂ material 210, which is illustrated in FIG. 2. In step 102, chemical exfoliation is applied to the bulk MoS₂ material 210 to obtain chemically exfoliated MoS₂ (ce-MoS₂) material 220. Note that the step of chemical exfoliation transforms the physical structure of the bulk material into nanosheet material. Also note that a chemically exfoliated material has no 3D structure, i.e., there are only 2D sheets of that material floating in a solution, but there is no engineering applied to the plural 2D sheets to generate new properties of this material or to combine these nanosheets into a new 3D configuration. As discussed later, the 3D architected MoS₂ foam acquires novel properties due to its novel 3D configuration, which are not present in the corresponding bulk material or 2D sheets.

Next, the chemically exfoliated ce-MoS₂ material 220 is exposed in step 104 to a Li-solution for achieving Li-intercalation. This step is accomplished by immersing, for example, 2 g of MoS₂ powder in 15 ml of 0.8 M n-butyl Li in hexane. The newly obtained mixture 222 may be stirred vigorously in an Ar-filled glovebox for 96 h. The compound is then filtered over Whatman filter paper and rinsed with 300 mL hexane. Note that all the specific values disclosed herein are provided to enable one skilled in the art to reproduce the architected foam. However, those skilled in the art would understand that deviations by 10 to 20% from these values, either negative or positive, are possible and would also generate the architected foam. To indicate this deviation, the term “about” is used herein.

Next, the intercalated compound 222 was transferred into a container holding 150 mL deionized water (DI-H₂O) to hydrate the Li material in step 106, which results in an increased volume between the various 2D nanosheets of MoS₂. After ultrasonication, the compound was repeatedly washed over Millipore filter paper. The resulting monolayer MoS₂ sheets were resuspended to 250 μg/ml in a mixture of deionized water and isopropyl alcohol (DI-H₂O: IPA=7:3, v/v) and this composition 224 was placed into another container as illustrated in FIG. 2.

If instead of MoS₂ architected foam, an MXene based foam is desired, then TisAlC₂ powder (˜50 μm) is chemically exfoliated by hydrochloric acid (HCl)+lithium fluoride (LiF) etchant. 1 g of TisAlC₂ powder can be slowly added into a mixture of 0.666 g LiF in 10 mL of 9 M HCl, followed by stirring at 35° C. for 24 h. The acidic suspension was washed with ethanol and centrifuged several times until pH>6 is reached. The sediment was collected, followed by adding 50 mL of DI water. After sonication and subsequent centrifugation at 3,500 r.p.m., a stable colloidal suspension of delaminated Ti₃C₂Tₓ MXene was obtained and the concentration of the Ti₃C₂Tₓ MXene suspension was regulated to 0.5 mg/mL in a mixture of DI-H₂O and ethanol (1:1, v/v) and provided as compound 224 for dewetting processing.

Next, in step 108, the liquid composition 224 was supplied to an electrohydrodynamic (EHD) printing system 260, as shown in FIG. 2. The EHD printing system 260 includes a container 262 for holding the composition 224, an electrically grounded substrate 264 on which the MoS₂ foam is formed, and a height adjustment mechanism 266 for adjusting a height of a nozzle (or needle) 268 of the container 262 relative to the substrate 264. A controller 270, which may be a processor or a smart device, controls the height adjustment mechanism 266. A power source 272 is electrically connected to the nozzle 268 of the container 262 with one of its leads and to the substrate 264 with the other lead. The power source 272 may be a DC power source that is able to supply high voltages, in the kV range so that an electrical field of 0.75 to 0.85 kV/cm² may be established. The controller 270 is also programmed to control when this intense electrical field is supplied between the nozzle 268 and the substrate 264. The substrate 264 may be made of any metal, for example copper (Cu). Further, the EHD printing system 260 also includes a fluid pump 280 that is fluidly attached to the vessel 262 and configured to regulate the amount of the composition 224 that is forced through the nozzle 268 onto the substrate 264. The fluid pump 280, which may be located inside or outside the vessel 262, may be controlled by the controller 270 to adjust the amount of material 224 being distributed over the substrate 264.

In one application, the controller 270 also controls a moving mechanism 284, which is attached to and supports the printing system 260, so that the nozzle 268 is moved along a desired path over the substrate 264 to cover the substrate with a desired amount of the material 224. The nozzle 268 may be selected to have a desired internal diameter, so that in tandem with the amount of electrical field applied between the nozzle and the substrate, the ejected compound 224 forms jets 286 or particles 288. In other words, the controller 270 can control various parameters of the printing system 260 to supply jets 286 of the compound 224 or particles 288, on the substrate 264.

Next, the EHD printing system 260 is programmed to spray the substrate 264 with the compound 224 according to the following scheme. In step 108, which corresponds to a jetting mode, no voltage is applied by the source 272 to the needle/nozzle 268 and the ce-MoS₂ compound is sprayed continuously along a predetermined path on the substrate 264 until an entire area 264A is covered with a liquid thin film 290 of ce-MoS₂ nanosheets, having a thickness below a critical thickness T_{c}. During this step and the next one, the substrate is heated, for example, with a heater, at a desired temperature, in this case, 180° C. The flow rate of the feeding material 224 is carefully maintained by the controller 270 at about 7 μL/min to achieve the high yield of architected MoS₂ foam. With matching surface chemistry and boundary conditions, the thickness of the ce-MoS₂ containing thin film 290 remained below the critical thickness and then spontaneously dewet to drive the pattern formation that regulates the 2D ce-MoS₂ sheets into hierarchically structured 3D architected MoS₂ foam 300. The aerial mass loading of deposited architected MoS₂ foam hinges on the deposition time. In one application, a high-speed camera was implemented to observe and adjust the flow rate in a timely fashion, thus suppressing the unwanted formation of ce-MoS₂-containing droplets 288. The deposition yield was found to linearly scale with the flow rate, and a duration of dewetting-driven destabilization (DDD) process. A circular-shaped anode can be directly cut from the substrate with a punching machine. Note that no binders, additives or conductive paste were used to prepare the architected MoS₂ foam 300 anode for the Li-ion battery.

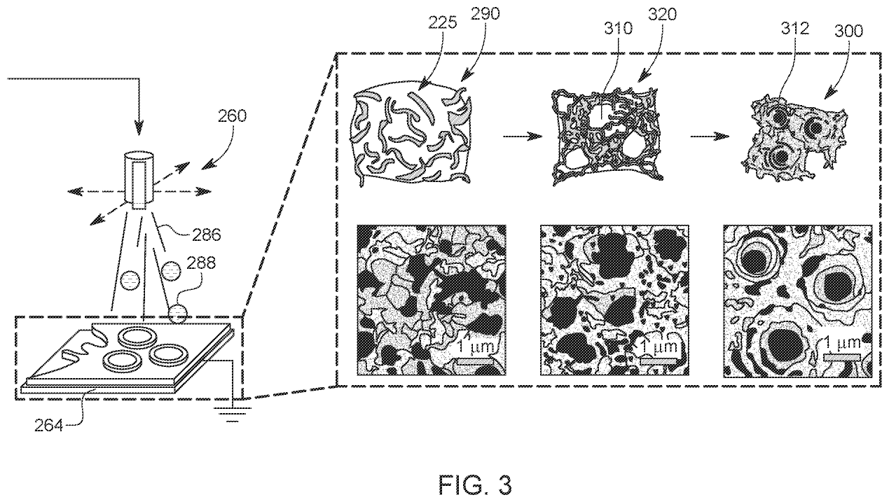

The critical thickness is defined as now discussed. Basically, the underlying mechanisms governing the way liquid films recede are somewhat akin to those involved in phase transitions. The liquid thin film can be metastable and thus, it dewets by nucleation and expansion of drying patching under the critical thickness (T_{c}). To determine the T_{c} that accounts for this transition, the puddle thickness is adopted herein, i.e., the critical thickness is defined to be given by T_{c}=2κ⁻¹ sin (θ/2), where κ⁻¹ and θ are the capillary length and contact angle of H₂O, respectively. Selecting for the capillary length κ⁻¹ a value of 2.7 mm, and for the contact angle θ a value of 15° measured on Cu substrates, it is possible to extrapolate that T_{c}≈0.7 mm. Indeed, the density of drying patches 310, shown in FIG. 3, surges if the initial thickness of the ce-MoS₂ containing liquid thin film 290 is greatly reduced (see discussion in [4]) below the T_{c}. This is probably due to the substantially increased nucleation sites as the dewetting proceeds. Once the foam-like puddle pattern is formed, as shown in FIG. 3, ordering is induced among the disordered ce-MoS₂ stacks 225 of the compound 224. Specifically, the electrostatic charges 288 enable the ordered arrangement of monodisperse droplets into periodic arrays upon impacting the liquid surface, closely resembling the breath figures. The result is the appearance of spatially organized ripples that emit capillary waves 312 directed downstream, creating ordered arrays of nucleation sites for drying patches. Note that in this step, the compound 224 is sprayed as jets 286 over the surface of the Cu substrate 264.

Next, a voltage is applied in step 109 (from the voltage source 272) between the nozzle 268 and the substrate 264. In step 110, which is the spraying mode, ultrafine and electrostatically charged droplets 288 are generated due to the applied voltage, and the charged droplets have a narrow distribution of diameters. Thus, during this step/mode, the compound 224 is dispersed in a discrete manner over the existing thin film 290 generated in step 108. This means, that the controller 270 uses the moving mechanism 284 to move the nozzle 286 again over the substrate 264 and over the thin film 290, to distribute the charged droplets 288. Because of the large electrical field generated by the source 272, the jets 286 are transformed into the discrete particles/droplets 288. The bombardment of the thin film 290 with the charged particles 288 creates in step 110 drying patterns 320, thus regulating the randomly dispersed 2D ce-MoS₂ 225 into an orderly 3D architected assembly 300, i.e., the MoS₂ architected foam.

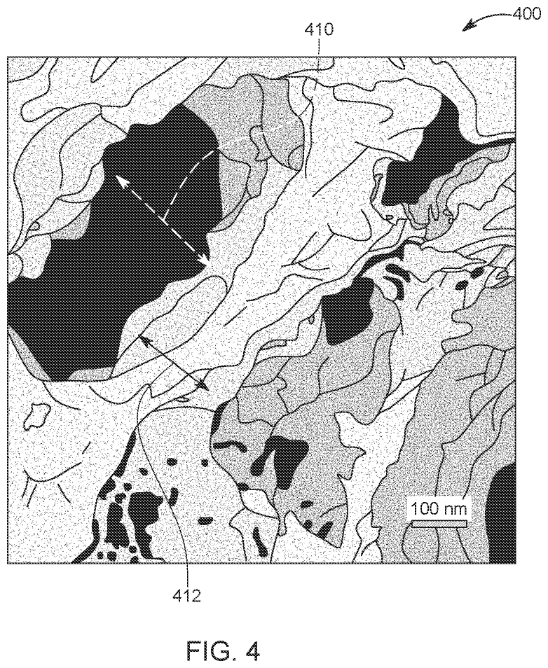

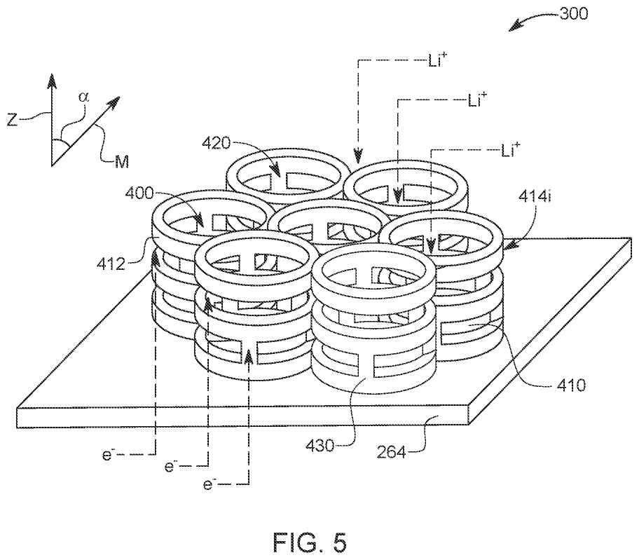

The formation of the 3D architected MoS₂ foam 300 is driven by the spontaneous phase segregation in step 112, which confines the dispersed ce-MoS₂ sheets 225 to the area between drying patches 310 (see [5] about this mechanism). This leads to the formation of a localized network of nanopores 410 and struts 412 (see FIG. 4) similar to cellular foam as schematically represented in FIG. 5. The size of the nanopores is about 200 nm and the thickness of the struts 412 is about 72 nm. Various struts 412 define a cell 400. Plural cells are formed in a given plane 414i, with a value of “i” being between 1 and 30. Note that during the manufacturing process, plural planes 414i are used. Each passing of the nozzle 268 above the substrate 264 forms a corresponding plane. Thus, the number of times the nozzle passes a certain area of the substrate corresponds to the number of planes formed on the substrate. Plural adjacent cells from different planes form a channel or tunnel or conduit 420 (also called vortical truss unit cell), which happens during the spontaneous phase segregation in step 112, and these channels 420 extend through the thickness of the foam, i.e., from one plane to another plane. A channel 420 extends at least between two consecutive planes. However, more often than not the channel 420 extends through plural planes. In one application, it is possible that the channels 420 extend through all the planes. Thus, a channel 420 may be bordered or defined by plural cells 400 that extend in different parallel planes.

After the formation of one single layer on the substrate 264, the method may return in step 114 to step 108 to spray another layer of the ce-MoS₂ material 224 onto the formed first layer of such material, and then spray the compound particles to form additional cells and struts and pores, and to increase a size of the existing channels 420. This process can be repeated until a desired number of layers is obtained, for example, between 1 and 30. A larger number of layers may be generated with the method discussed herein.

As also shown in FIG. 5, the various struts 412 that define the channels may be held together by vertical viaducts 430, which connect adjacent parallel planes/layers to each other. An orientation of the channel 420 depends, as discussed later, on the orientation of the needle 268 relative to the substrate 264. As further illustrated in FIG. 5, the orientation of the channels 420 may be similar, i.e., along a vertical axis Z for this specific embodiment. Note that the planes 414i in this figure are formed on top of each other, along the vertical axis (Z). This means that an orientation of the channels 420 may be controlled by changing the orientation of the substrate relative to the needle during the manufacturing process. For example, if the substrate 264 is inclined with a given angle α relative to the vertical orientation of the nozzle 268, i.e., along a direction M as shown in FIG. 5, the orientation of the plural channels 420 would be along the direction M although the planes 414i are still arranged on top of each other along the direction Z. The angle α may be zero or non-zero, as desired by the manufacturer of the foam 300. Plural channels 420 are formed in the foam 300. An internal diameter of the channel 420 may be between 100 and 600 nm.

Although a detailed mechanism for this foam-like pattern formation is yet to be explored and maybe rather complicated, an elegant insight is readily gained from the experimental observation and simple predictive model. The nucleation sites of drying patches 310 seem to be closely associated with the local thickness of the retreating liquid thin film 290, which can be empirically associated with the critical thickness T_{c}. This sheds light on the possibility of creating ordered arrays of patterns and the concomitant porosity if the local thickness of the liquid thin film 290 can be spatially regulated during the dewetting phase. A very convenient approach for spatially controlling the local thickness of the liquid thin film 290 is the electrohydrodynamic printing process discussed above with regard to FIG. 1 and schematically illustrated in FIG. 3.

When the dewetting patterns are set, the emergence of cells 400 (which are defined by one or more pores 410 and are associated with plural struts 412, see FIG. 5) depletes the solvents at the truss-air contact line, which in turn creates a swirling force that guide the successive deposition of ce-MoS₂ containing droplets 288. During this step, the ce-MoS₂ are continuously carried off by the droplets 288 at the truss-air contact line and preferentially deposited along with the 3D porous framework, thus enabling the continuous production of new layers of rings and struts in a way similar to additive manufacturing.

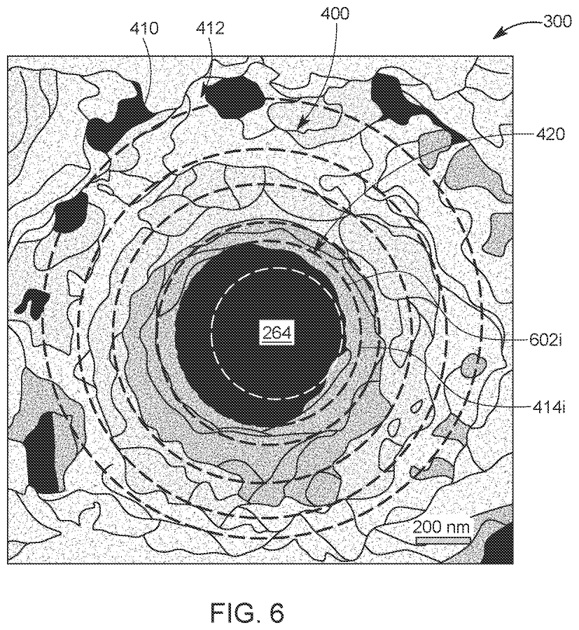

This manufacturing process is particularly appealing because of the ability to join the simplicity of geometric patterns to the complexity of hierarchical architectures in a scalable fashion. Previous demonstrations of 3D architected TMD foam have been constrained by either the scalability of the manufacturing routes, 3D features with limited orders of magnitude, or the dimensions of scaffolds [6], [7]. On the contrary, the disclosed multiscale structural features of the 3D architected MoS₂ foam 300 were found to distribute ubiquitously and uniformly in both lateral and vertical directions regardless of the printing area (4-inch wafer) and thickness (>100 μm) as shown. From FIG. 6, a truss unit cell 420 may extend over plural layers 602i of alternating rings 410 and struts 412, tapering down toward the bottom of the Cu substrate 264. Note that the dashed lines added in FIG. 6 correspond to both a plane 414i and also a layer 602i, as each layer 602i extends in a corresponding plane 414i. Thus, the number of layers corresponds to the number of planes for a given foam 300. These nanoscale struts made of intertwined and folded ce-MoS₂ sheets 225 serve as the novel elements that structurally interconnect between layers of concentric rings, forming vertically stacked and ring-shaped viaducts 430 [8]. These viaducts 430 naturally define abundant transverse pores (pore size in the range of ˜200 nm) on the sidewalls of the channels or the vortical truss unit cells 420. A further closeup view of these struts reveals a high density of tears and holes on the order of 5-20 nm. It was further observed that the foam 300 features a high percentage of atomically resolved defects, such as S-vacancies, derived from the harsh Li intercalation reaction. Note that a direction of the channel 420 relative to the substrate 264 may be changed from a vertical position, as shown in FIG. 6, to any orientation (angle), even horizontal, by either inclining the substrate 264 relative to the nozzle 268, or changing an orientation of the nozzle 268 relative to the substrate 264, or doing both of them.

To further examine the ubiquity and uniformity of multiscale structure features in the lateral direction of the foam 300, a series of scanning electron microscopy (SEM) images (not shown) were taken from different perspectives with respect to the center truss unit cell. From the analysis of these images, it was observed that all the truss unit cells include at least five layers of alternating rings and struts shaped down toward the Cu substrate. In addition, tilted angle SEM images further reveal the uniform thickness and ordered arrangement of struts in tandem with the narrow size distribution of nanopores. The architected MoS₂ foam 300 was found to strongly attach to the underlying Cu substrate and can only be made free-standing through dissolving the Cu substrate in ammonium persulfate solution. The difficulty of removing MoS₂ foam from the underlying Cu substrate underscores the strong adhesion that ensures establishment of uninterrupted conductive pathways. Further, a close examination of the surface morphology from the back side of the architected MoS₂ foam enabled the inventors to correlate the predictive model with experimental observation. It was observed that the advent of vortical truss unit cells confirms the formation of dewetting patterns in the initial stage. Note that a wide distribution in pore sizes that is sporadically distributed between heavily aggregated sheets in the backside of the foam may stem from the occasional appearance of large pendant droplet during the initial deposition (areal loading less than 0.5 mg/cm²). Truss unit cells begin to tessellate and then propagate vertically when the areal loading exceeds 0.5 mg/cm². Together, these morphological characterizations collectively attest to the scalable uniformity of the dewetting-assisted manufacturing route to create architected patterns with multiscale structural features in all directions over the entire substrate. Other characterizations, including binding energies from X-ray photoelectron spectroscopy (XPS), characteristic peaks from X-ray diffraction (XRD), signatures from Raman spectra and energy dispersive X-ray spectroscopy (EDS) mapping of relevant elements in a single truss unit cell as well as within the 3D networks, prove again the structural continuity and chemical coherence of the architected MoS₂ foam 300.

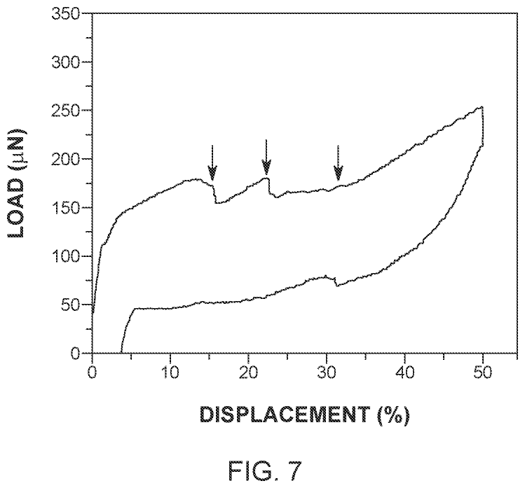

The characteristic failure and post-yield deformation of the architected MoS₂ foam 300 were observed through a programmable nanoindentation experiment that incorporated three stages in each cycle, as follows, (1) compressing the same point of the foam 300 with a displacement of 50% of the total thickness of the foam, during a 10 s time interval; (2) holding the compression for 10 s; and (3) releasing the load in 10 s. The post-yield deformation behavior of the architected MoS₂ foam 300 was characterized by a ductile-like behavior with the continuous serrated flow as illustrated in FIG. 7. Catastrophic failure was attenuated by a combination of elastic ring buckling, shell buckling in individual struts, sliding between stacked sheets, and microcracking at nodes. This is manifested in the highest average recovery among all restructured MoS₂ anode materials, with the architected MoS₂ foam 300 recovering up to 85% of its original height (100 μm as determined by the cross-sectional SEM) after compressions exceeding 50% strain. Failure in the 3D hierarchically structured foam carried out and localized primarily in the densification of individually protruded vortical truss cells. Puckering of these interconnected vortical truss cells creates an adaptable region in the higher-order networks that accommodate most of the ensuing displacement. Upon unloading, most of the vortical truss cells within the 3D porous networks, in both vertical and lateral directions, remained intact by virtue of the global recovery. This results in the excellent adaptability of the 3D architected MoS₂ foam 300, which may be translated to withstand the volume change during the charging/discharging process of a Li-based battery. By contrast, the reference crystalline bulk, and restacked wrinkled films display a nearly zero recovery and complete fracture when the applied loads exceed 100 μN, while the crumpled balls of MoS₂ show the strain-hardening effect. Note that the restacked wrinkled films and the crumpled balls were each made of MoS₂, but they did not have the architected features discussed above for the foam 300 (i.e., nanopores, viaducts, struts, and truss unit cells). These differences in the mechanical adaptability between the foam 300 and the other 3D shaped MoS₂ structures underline the role of the novel 3D structure illustrated in FIGS. 4 and 6, in facilitating load dissipation and structural resilience, necessary for negating the electrochemomechanical fatigue and fracture in the MoS₂ anode.

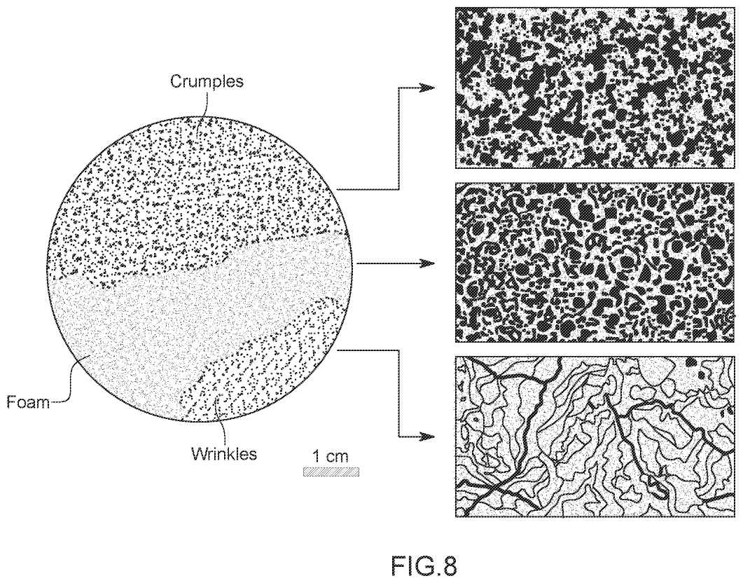

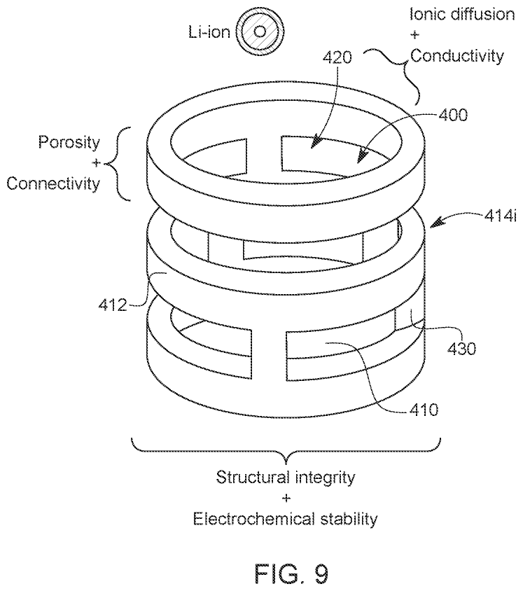

In addition to the superior structural integrity and preserved chemical coherence, another appealing feature of the 3D architected foam 300 is its strained structure that provides a new degree of freedom to manipulate the intrinsic activities of the 2D MoS₂ building blocks 225, especially those relevant to Li-ion batteries such as diffusion barrier, adsorption and conductivity. FIG. 8 shows a 2-inch Cu substrate printed with MoS₂ with various morphologies, including crumples (top), architected foam 300 (middle), and wrinkles (bottom right), made possible by the programmable dewetting-driven destabilization procedure. The strain-charge doping (ε-n) map (not shown) derived from the linear relationship between biaxial strain/charge doping and Raman shifts provides an index for quantifying the strain load (characterized to shift by ˜1.7 cm⁻¹ per % strain) and surface electron densities. Note that Δε>0 is indicative of tensile strain and Δn can be used to compare the relative electron densities. It was found that the architected MoS₂ foam 300 is substantially strained (˜1.75±0.15% vs. 3.2±0.37% of tensile strain in crumples, based on the redshift magnitudes of the Raman E_{2g} and A_{1g} peaks) and displays a relatively higher electron density than that of the wrinkled counterpart. These results agree well with the previous reports and are relevant for activating the MoS₂ foam with the significantly decreased ion diffusion barrier with ˜0.2 eV for Li, and greatly improved conductivity of 4.66 S/m relative to that of pristine 2H—MoS₂ bulk (0.42 eV for Li-ion diffusion barrier and conductivity of 0.0576 S/m). This behavior is not surprising given that the pristine 2H—MoS₂ bulk material possesses semiconducting as well as anisotropic charge transport properties. In parallel, the strain-induced upshift of Mo d states towards Fermi level gives rise to a stronger interaction with metal ions, which in turn tailors the storage capability. Together, the combination of manufacturing scalability, 3D hierarchically porous and spatially interconnected networks, architectural features that span across multiple length scales, and strain-engineered ion diffusion barriers and conductivity has made the architected MoS₂ foam 300 an ideal anode alterative with high-rate, high-capacity, high-mass-loading storage and long-term cyclability. FIG. 9 schematically correlates these appealing features with the formation of hierarchical structures within the 3D architected MoS₂ foam 300.

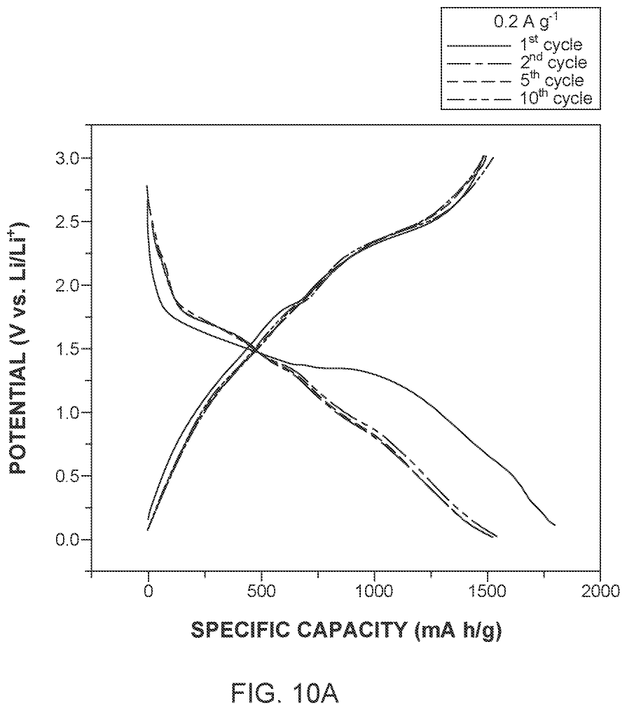

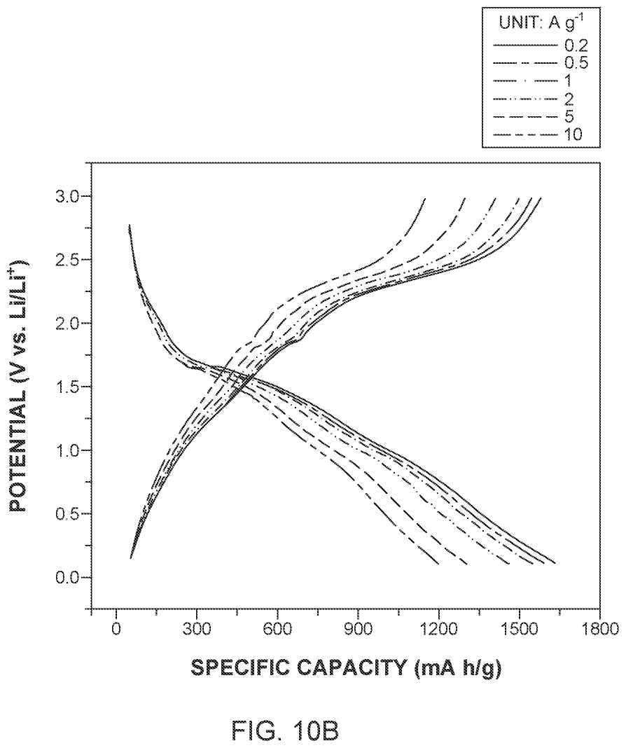

The printed architected MoS₂ foam 300 (1.25 mg/cm², containing 0 wt % additives) was analyzed by using the finite element methods (FEM) program, the COMSOL™ package. Here, the state-of-charge (SOC) of the pristine architected MoS₂ foam is defined by the degree of lithiation, e.g., SOC of 100% can be translated into fully lithiated/charged MoS₂ foam where pristine or un-lithiated MoS₂ foam is defined as SOC of 0%. From the FEM results, it becomes apparent that the spatially connected vortical truss unit cells help dissipate the localized strain over the entirety of the architected MoS₂ foam 300, limiting the volumetric expansion and thus preserving its structural integrity. In parallel, numerical calculations (not shown) indicate that, at a fully lithiated state (SOC of 100%), the evolved von Mises stress distribution remains very low (˜few MPa), confirming the efficacy of the architected MoS₂ foam 300 [9]. Indeed, the superior electrochemical performance of the architected MoS₂ foam 300 validates the theoretical prediction discussed above. An architected MoS₂ foam anode can be obtained from disc-punching the wafer-scale batch printing with a high yield and displays an initial discharge and charge capacities of 1797 and 1490 mAh/g at the constant current of 0.2 A/g in a voltage range of 0.01 to 3.0 V versus (Li/Li⁺) as shown in FIGS. 10A and 10B. The inventors have tested 100 architected MoS₂ foam anodes derived from the 4-inch-wafer-scale fabrication at different batches, and they showed a high yield of 99% with averaged reversible discharge capacity of 1575 mAh/g at the 2^{nd} cycle with an initial Coulombic efficiency of more than 95%.

In parallel, the charge/discharge profiles measured at various cycles in FIG. 10A show plateaus at 1.4 V and 0.9 V in the discharging process, respectively. These two plateaus remain discernable at increased current densities (0.2-10 A/g), indicating excellent reaction kinetics between Li⁺ and the architected MoS₂ foam 300. However, none of these two plateaus is characteristic of the pristine MoS₂ nanosheets that typically undergo an intercalation reaction (1.1 V) and an ensuing conversion reaction at lower voltages (0.55 V). The absence of both intercalation and conversion reactions points to the presence of new electrochemical storage kinetics.

Here, the presence of characteristic 2H peaks in ex-situ Raman and X-ray photoelectron spectroscopy (XPS) spectra collectively ruled out the 2H to 1T phase transition, commonly observed in pristine MoS₂ bulk or stacked nanosheets. To probe the dominant electrochemical charge storage kinetics in the architected MoS₂ foam 300, it is necessary to verify the capacity contribution from the diffusion-controlled and the capacitive processes. The pseudocapacitive process contributes a significant fraction of the overall capacity at low rates (˜82.8% capacitive at 1 mV s⁻¹) and predominates at high rates (>99% capacitive at 5 mV s⁻¹), making it possible for high-power operation.

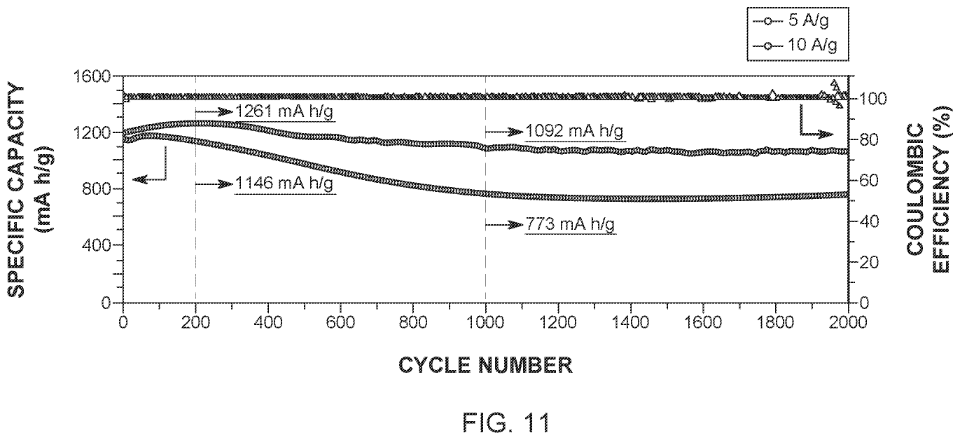

The high-yield production of the architected MoS₂ foam 300 with enhanced electrochemical performance can be attributed to the two recognizably different characteristics. The first is the spatially uniform networks of vertically vortical truss unit cells/channels 420 that retain the structural integrity while facilitating the stabilization of solid electrolyte interphase (SEI). After 200 deep cycles, the hierarchically structured morphology remains intact and is coated with a thin yet uniform layer of SEI (about ˜100 nm. A statistical analysis of both channel dimensions and nanopore diameters reveal a less than 10% increase, crucial for stable capacity retention in high mass loading cells. By contrast, random and disordered packing of MoS₂ sheets resulted in the rampant growth of SEI and congestion of transport pathways. Meanwhile, the structural hierarchy that spans multiple orders of magnitude spatially confines the SEI formation and quantitatively decreases the SEI thickness, closely resembling the double-walled Si nanotubes and the pomegranate-inspired design strategy. The synergistic combination of volumetric-expansion-tolerant truss unit cells and multiscale hierarchy effectively suppresses the rampant formation of SEI and thus increases the Coulombic efficiency as well as the cycling stability. In this regard, FIG. 11 demonstrates the retention of a specific capacity at a high charge-discharge current density beyond 5 A/g and electrochemical stability at a mass loading of 1.25 mg/cm². The architected MoS₂ foam anode delivered a reversible capacity of 1092 mAh/g after cycling at 5 A/g for 2000 cycles, and a reversible capacity of 773 mAh/g after cycling at 10 A/g for 2000 cycles, respectively. The energy density is around 2385 Wh/kg and power density is ˜9540 W/kg under 5 A/g current density. Under 10 A/g current density, energy density is 2106 Wh/kg and the power density reaches 20963 W/kg. Notably, the fast-charging capability of the architected MoS₂ foam anode holds the tantalizing prospect of potentially rivaling the ICE with a short refueling time of no more than 10 minutes and a cell level energy density of no less than 350 Wh/kg.

The spectroscopic characterization of operando Mo K-edge X-ray absorption near edge structure (XANES) corroborates the electrochemical redox (pseudocapacitive) reaction of architected MoS₂ foam anode. The Mo K-edge XANES spectra (not shown) of the architected MoS₂ foam anode during the first discharging (lithiation) and charging (delithation) processes at a scan rate of 0.3 mV s⁻¹ has been acquired. It is worth noting that the absorption edge does not shift discernably during the first cycle. This reveals that the oxidation state of Mo does not change significantly. To further understand the oxidation state change of Mo ions, the XANES spectra for the first cycle with the potentials at an open-circuit voltage (OCV), the first full lithiation (0.01 V), the first full delithiation (3 V), and the references (MoO₃ and Mo metal foil) were also analyzed. The position of the absorption edge of the architected MoS₂ foam anode slightly shifts to a lower energy during the discharging (lithiation) process and then reverts back during the charging (delithiation) process. The changes in the edge energies and shifts in absorption edges collectively indicate that part of the reversible capacity is contributed by the redox reaction of Mo ions. However, the edge energy for all lithiation/delithiation spectra are within only c.a. 1 eV of the MoS₂ foam anode, which may be due to the anion-cation redox interactions between the Mo and S ions as observed in the literature.

In addition, the fingerprint feature of metallic Mo at c.a. 20016 eV was not observed in the fully lithiated electrode (0.01 V), revealing that the metallic Mo was not formed during the lithiation process. This shows that the conversion reaction did not occur during the lithiation process, thus giving rise to excellent cycling stability. This result is different from the commercial micrometer-sized MoS₂ electrode where the metallic Mo was detected in the Mo K-edge XANES spectrum of the lithiated electrode. Moreover, the large capacity of up to 1500 mAh g⁻¹ is mainly due by virtue of the surface-limited capacitive mechanism. The CV curve and the energy shift of the x-ray absorption edge ΔE_{edge} during the first cycle were also determined, where ΔE_{edge} is defined by the energy difference between the second inflection points of OCV (c.a. 20018 eV) and certain potentials. These curves show that the edge energy decreases steeply from 2 V to 0.9 V vs. Li/Li⁺ during the discharging process and increases sharply from 1 V to 3 V vs. Li/Li⁺ during the charging process. These potential ranges bear a close resemblance to the peaks on the CV curve. Moreover, these peaks on CV curve still can be recognized even at high scan rate of 10 mV s⁻¹, revealing fast redox reactions. As a result, those redox couples are mainly contributed by the pseudocapacitive reactions of Mo ions, and the rest current is contributed by electrical double layer capacitive reactions. The strategy of hierarchical structuring and additively manufacturing 2D ce-MoS₂ to optimize Li-ion electrochemical activity is thus grounded in the emergence of the pseudocapacitive mechanism of 3D architected MoS₂ foam 300.

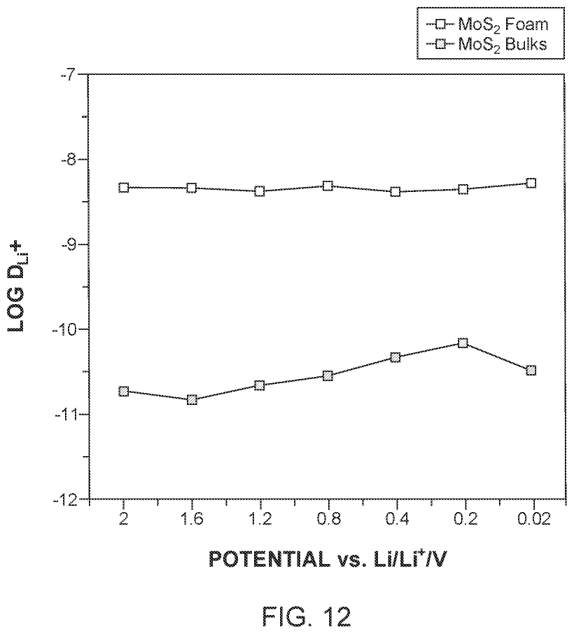

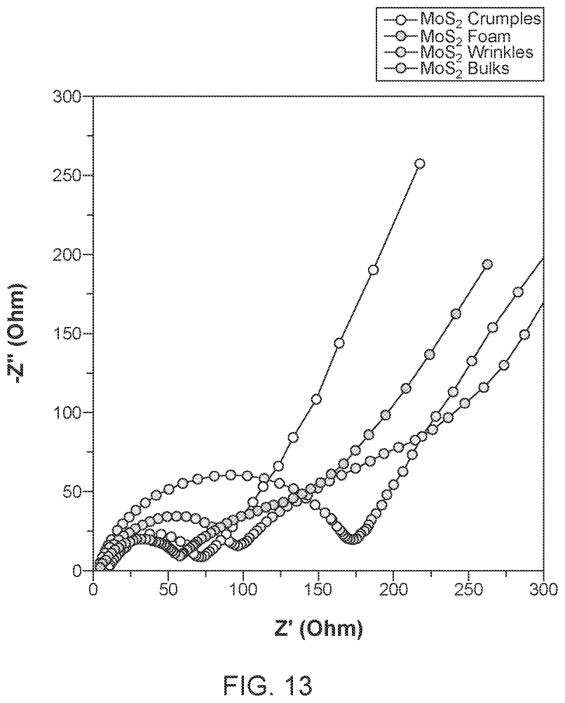

Another advantageous feature of the architected MoS₂ foam anode is the superior reversible capacity when compared to other pristine MoS₂-based anodes in various forms, such as crumples, wrinkles, and bulks, in both static and dynamic conditions. Also, the ability to continuously print out new layers of rings and struts that concurrently establish effective charge transport networks and ion transport pathways is manifested in overcoming the areal capacity-areal mass loading dilemma. To this end, the inventors printed out the architected MoS₂ foam anode with an aerial mass loading of 3.5 mg/cm² (higher aerial loading can be achieved simply by increasing the deposition time). The spatially connected yet hierarchically structured 3D networks were observed throughout the entirety of the foam regardless of the increased aerial mass loadings. Electrical impedance spectroscopy (EIS) measurements were then performed and the results were compared with those for the control anodes, such as bulks, wrinkles, and crumples on an equal footing with areal loadings of 3.5 mg/cm², respectively. The derived Li⁺diffusion coefficients (D_{Li}) in the architected MoS₂ foam 300 were found to be two to three orders of magnitude higher than that in MoS₂ bulks, as illustrated in FIG. 12. Ohmic (Rₛ), solid electrolyte interface (R_{SEI}) and charge transfer resistance (R_{ct}) can be extrapolated from the intercept, and diameters of the semicircles from the Nyquist plots as shown in FIG. 13.

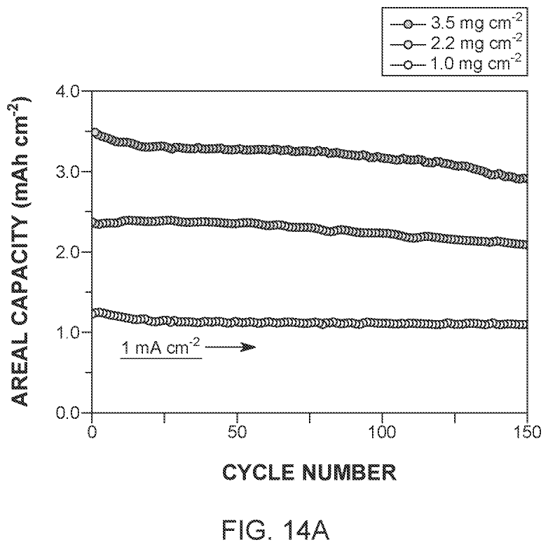

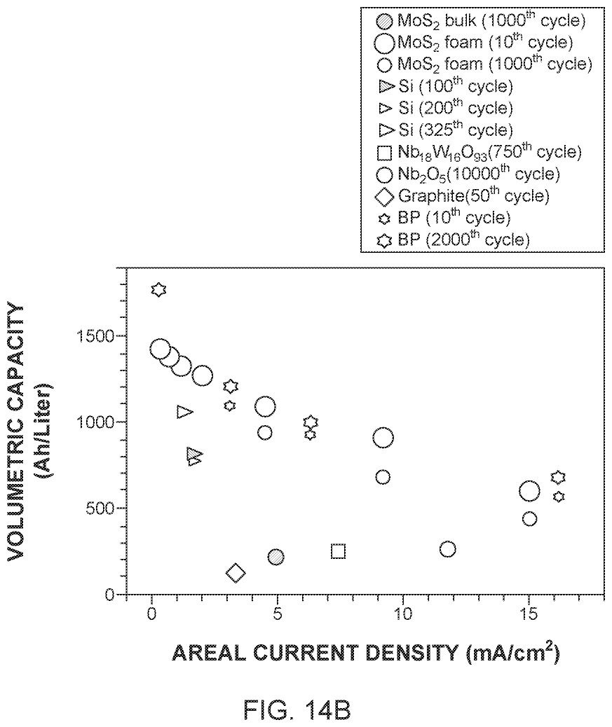

Following the initial deep cycling of 0.05 mA/cm² (1^{st} to 3^{rd} cycle) and the subsequent high rate of 1 mA/cm² (4th to 150th cycle), the architected MoS₂ foam anodes with areal loadings of 1.0 mg/cm² and 2.2 mg/cm² can achieve 150 cycles without noticeable degradation of areal capacity. Notable, increasing the areal loading to 3.5 mg/cm² gives rise to the reversible areal capacity of 3.45 mAh/cm² and remains above 3 mAh/cm² after 100 cycles as shown in FIG. 14A, comparing more favorably than the capacity in a commercial Li-ion battery. Finally, the inventors calculated the volumetric capacity of the architected MoS₂ foam anodes with an overall packing density of 0.95±0.05 g/cm³. Note that such an overall pack density is only slightly lower than that of the standard graphite anodes (˜1.0 g/cm³). By combining gravimetric capacity and electrode packing density, the inventors benchmarked the performance with those of known high-rate anodes made of conventional graphite, emerging BP, Nb₂O₅, Si and pristine MoS₂ (see FIG. 14B). The architected MoS₂ foam anode exhibits a volumetric capacity of 1152.6 Ah/Liter at 4.5 mA/cm² after 1000 cycles and 500 Ah/Liter at 15 mA/cm², exceeding most of the above-mentioned anodes and comparing favorably to the 2D BP benchmark with the similar performance if not better. Importantly, the ability to upscale the production of such architected MoS₂ foam with both high mass- and volumetric-specific capacity embodies an important step forward toward Li-ion batteries with high-energy and high-power performance.

Because the novel DDD approach is directed at the combination of dewetting and thinning of 2D TMDs-containing liquid thin films, which can be achieved with the electrohydrodynamic printing, its use can be extended to a wider variety of “2D inks,” including rGO and titanium carbide (Ti₃C₂Tₓ, metallically conductive MXene), with precise control over structural hierarchy, multiscale porosity, conductive pathways, and spatial connectivity at wafer-scale. The inventors have observed that a high-performance Li-ion battery based on the architected MXene foam anode at a high-mass loading level (3 mg/cm²) is possible with similar manufacturing conditions as those developed for architected MoS₂ foam as discussed above. This indicates that this novel, versatile yet generalized DDD manufacturing scheme provides a new avenue for the deposition and self-organization of atomically thin 2D layered sheets into hierarchically porous, globally uniform, structurally adaptive and electrochemically activated anodes for high-rate, high-capacity and high-mass-loading energy storage. In parallel, this methodology represents a very visible nexus to merge a variety of 2D layered material engineering designs, where the combination of contact engineering, compositional heterostructuring, chemical tethering, phase engineering, electronical coupling and defect tailoring at successive length scales will collectively give rise to new combinations of properties not seen in either bulk- or atomically-scale materials. Thus, the embodiments discussed herein can be used for enabling applications beyond Li-ion batteries and for integrating materials beyond MoS₂.

For some of the tests discussed above, the working electrodes were directly printed on a Cu current collector. The loading level of spatially homogeneously architected MoS₂ foam 300 was about 1, 2.2 and 3.5 mg cm⁻², respectively, and for the cases of MoS₂ crumples, MoS₂ wrinkles and MoS₂ bulk were about 1 mg cm⁻², respectively. Note that although the MoS₂ foam, MoS₂ crumples, MoS₂ wrinkles and MoS₂ bulk include the same chemical elements, the 3D distribution of the nanosheets making up these materials and the various features (channels, cells, pores) present and their distribution in the 3D configuration of these materials severely distinguish the MoS₂ foam from the MoS₂ crumples, wrinkles, and bulk configurations. The MoS₂ foam electrodes were used as printed without additional processing steps (except those discussed above with regard to FIG. 1). All other electrodes were dried at 200° ° C. for 2 h, and then pressed until the density of the electrode became >1.0 g cm⁻³. The electrode thickness was about 100 μm for the architected MoS₂ foam electrode and 100 μm of the MoS₂ crumples, MoS₂ wrinkles, and MoS₂ bulk electrodes except for the Cu current collector. All electrodes were vacuum-dried at 50° C. overnight. CR2032 coin-type cells were assembled in an argon-filled glove box containing pure Li metal foil (1 mm) as the counter electrode. The electrolyte used for the experiments was 1.0M Lithium hexafluorophosphate (LiPF₆) in a mixture of ethylene carbonate (EC) and dimethyl carbonate (DMC) with a volume ratio of 1:1. A microporous glass fiber was used as a separator with a thickness of 19 μm. Galvanostatic cycling was conducted on a computer-controlled battery test system at different current densities in a potential range of 0.01-3.0 V. The Cyclic voltammetry (CV) tests were carried out to examine the electrode reaction under the scan rate of 1, 2, 5, 10 mV s⁻¹ with a voltage range of 0.01-3.0 V. Electrochemical impedance spectra (EIS) were recorded in a frequency range from 106 to 0.01 Hz, while the disturbance amplitude was 5 mV. All electrochemical measurements were under constant 25° C.

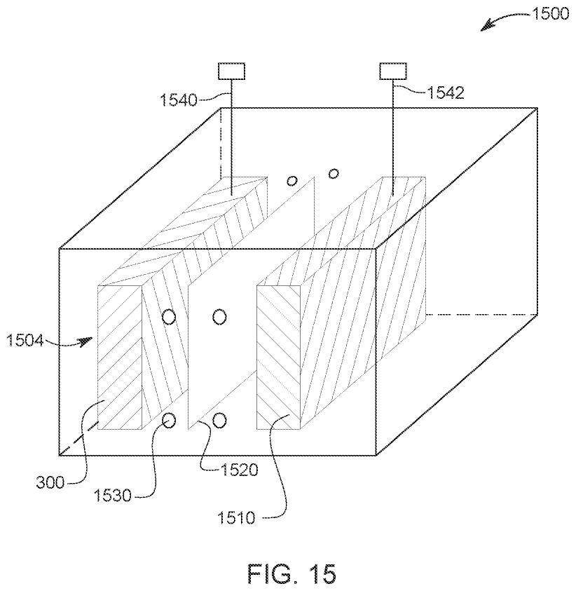

In one application, as illustrated in FIG. 15, a battery 1500 based on the architected MoS₂ foam 300 includes a housing 1502 that houses an anode 1504 (that includes the architected MoS₂ foam 300 with or without the substrate 264), a cathode 1510, a separation membrane 1520 and an electrolyte 1530. While the compositions for the cathode, separation membrane and electrolyte may be the traditional ones used for such a battery (e.g., LiFePO₄ (LFP) for the cathode, and LiPF₆ for the electrolyte), the anode's chemical composition and especially its physical configuration are replaced by the architected MoS₂ foam 300 discussed above. The battery may also include corresponding leads 1540 and 1542 or pads electrically connected to the anode and cathode, where the electrical energy is provided. In one application, the active material loading was 1 mg/cm² for the MoS₂ foam anode and 10 mg/cm² for the LFP cathode.

The disclosed embodiments provide an architected TMD foam that may be used as the anode of a Li battery. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

The entire content of all the publications listed herein is incorporated by reference in this patent application.
[1] H. Zhang et al., Three-dimensional bicontinuous ultrafast-charge and -discharge bulk battery electrodes. Nature Nanotech. 6, 277 (2011);
[2] X. Zheng et al. Multiscale metallic metamaterials. Nature Mater 15, 1100-1106 (2016).
[3] S. Wehner et al. Quantum internet: A vision for the road ahead. Science 362, 6412 (2018).
[4] Naffouti, M. et al. Complex dewetting scenarios of ultrathin silicon films for large-scale nanoarchitectures. Sci. Adv. 3, eaao1472 (2017).
[5] Estevez, L., Kelarakis, A., Gong, Q., Da 'as, E. H. & Giannelis, E. P. Multifunctional Graphene/Platinum/Nafion Hybrids via Ice Templating. J. Am. Chem. Soc 133, 6122-6125 (2011).
[6] Hu, G. et al. A general ink formulation of 2D crystals for wafer-scale inkjet printing. Sci. Adv 6, (2020).
[7] Guo, Y. et al. Additive manufacturing of patterned 2D semiconductor through recyclable masked growth. Proc. Natl. Acad. Sci. 116, 3437-3442 (2019).
[8] Liu, F. et al. Disassembling 2D van der Waals crystals into macroscopic monolayers and reassembling into artificial lattices. Science (80-.). 367, 903-906 (2020).
[9] Bertolazzi, S., Brivio, J. & Kis, A. Stretching and Breaking of Ultrathin MoS 2. ACS Nano 5, 9703-9709 (2011).

1. An architected transitional metal dichalcogenides, TMD, foam comprising:
plural layers of TMD arranged on top of each other along a given first direction Z;
each layer including plural cells;
each cell being defined by one or more struts made of the TMD;
plural channels extending along a given second direction M, which makes an angle α with the first given direction Z; and
plural pores formed on sides of the plural channels.

2. The foam of claim 1, wherein the TMD is MsO₂.

3. The foam of claim 1, wherein the TMD is rGO.

4. The foam of claim 1, wherein the TMD is MXene.

5. The foam of claim 4, wherein the MXene is Ti₃C₂Tₓ.

6. The foam of claim 1, wherein the angle α is zero.

7. The foam of claim 1, wherein the one or more struts extend in a corresponding plane and viaducts made of the TMD connect struts from adjacent planes.

8. A battery for producing electrical energy, the battery comprising:
an anode including an architected transitional metal dichalcogenides, TMD, foam;
a cathode;
a separating membrane that separates the anode from the cathode; and
an electrolyte,
wherein the architected TMD foam includes plural channels having nanometer sized internal diameters.

9. The battery of claim 8, wherein the architected TMD foam comprises:
plural layers of TMD arranged in top of each other along a given first direction Z;
each layer including plural cells;
each cell being defined by one or more struts made of the TMD;
plural channels extending along a given second direction M, which makes an angle α with the first given direction Z; and
plural pores formed on sides of the plural channels.

10. The battery of claim 8, wherein the TMD is MsO₂, or rGO or MXene.

11. A method for manufacturing an architected transitional metal dichalcogenides, TMD, foam, the method comprising:
providing bulk TMD;
chemically exfoliating TMD nanosheets from the bulk TMD to obtain chemically exfoliated ce-TMD;
spraying with a nozzle the ce-TMD as a jet onto a substrate to form a layer of TMD material with a thickness below a critical thickness;
applying a voltage between the nozzle and the substrate;
spraying with the nozzle the ce-TMD as particles onto the layer of TMD material; and
forming plural channels through the layer by dewetting the layer.

12. The method of claim 11, further comprising:
forming plural layers of TMD arranged in top of each other along a given first direction Z,
each layer including plural cells, each cell being defined by one or more struts made of the TMD material.

13. The method of claim 12, wherein the plural channels extend along a given second direction M, which makes an angle α with the first given direction Z.

14. The method of claim 11, further comprising:
intercalating Li between the ce-TMD before the spraying steps.

15. The method of claim 14, further comprising:
hydrating the intercalated Li before the spraying steps to increase a distance between TMD nanosheets.

16. The method of claim 11, further comprising:
heating the substrate to a given temperature and maintaining the temperature during the spraying steps.

17. The method of claim 11, wherein the TMD is MsO₂.

18. The method of claim 11, wherein the TMD is rGO.

19. The method of claim 11, wherein the TMD is MXene.

20. The method of claim 19, wherein the MXene is Ti₃C₂Tₓ.
